(19) United States
(12) Patent Application Publication
(10) Pub. No.: US 2013/0341110 A1
(43) Pub. Date: Dec. 26, 2013

(54) FOLDING AIR DAM

(71) Applicant: Albert H. Butlin, JR., Beverly Hills, MI (US)

(72) Inventor: Albert H. Butlin, JR., Beverly Hills, MI (US)

(73) Assignee: GM GLOBAL TECHNOLOGY OPERATIONS LLC, Detroit, MI (US)

(21) Appl. No.: 13/530,202

(22) Filed: Jun. 22, 2012

(51) Int. Cl. B60K 11/04; B62D 35/02

(52) U.S. Cl. 180/68.1; 296/180.1

(57) ABSTRACT

A system for controlling airflow through an under-hood compartment of a vehicle body includes a folding air dam assembly configured to control an airflow from the ambient to the under-hood compartment. The air dam assembly includes an extendable portion having a pleat configured to fold when the extendable portion is retracted. The air dam assembly also includes an actuator configured to selectively extend and retract the extendable portion. The system also includes a controller configured to regulate the actuator. A vehicle employing the system is also disclosed.

### TECHNICAL FIELD

The invention relates to a folding air dam for a motor vehicle.

### BACKGROUND

Among various other uses, motor vehicles frequently employ ambient airflow for cooling powertrain components situated in an under-hood compartment. Ambient airflow typically enters the under-hood compartment through a grille opening strategically positioned in a high pressure area on the vehicle body or from underneath the vehicle body.

A motor vehicle may also employ a front spoiler or air dam to control the amount of ambient airflow thus entering the under-hood compartment. Such an air dam may also be employed to control flow of air relative to the vehicle at speed to enhance vehicle dynamics and handling, as well as improve drag coefficient of the vehicle body, or generate down-force thereon.

Such an air dam is typically positioned under or integrated with the vehicle's front bumper. In order for an air dam to perform its function, however, the subject air dam may be positioned sufficiently low for some obstacles and obstructions found on road ways to interfere with the air dam and cause damage thereto.

### SUMMARY

A system for controlling airflow through an under-hood compartment of a vehicle body includes a folding air dam assembly configured to control an airflow from the ambient to the under-hood compartment. The air dam assembly includes an extendable portion having a pleat configured to fold when the extendable portion is retracted. The air dam assembly also includes an actuator configured to selectively extend and retract the extendable portion. The system also includes a controller configured to regulate the actuator.

The actuator may be a linear type. Additionally, the actuator may include a plurality of individual actuators.

The extendable portion may be characterized by monolithic or a single-piece construction and includes a curved shape configured to at least in part wrap around the first end of the body.

The extendable portion may include a segment disposed substantially orthogonal to the actuator and the actuator is attached to the segment.

The extendable portion may be configured from a resilient, i.e., tough but flexible, material.

The actuator may be configured to selectively extend and retract the extendable portion from a stowed position to an extended or deployed position, respectively, such that the extendable portion is set in a first height at the stowed position and in a second height at the deployed position, and wherein the first height is greater than the second height.

The actuator may include a network of shape memory alloy (SMA) elements integrated in the extendable portion. Accordingly, in such a case conduction of electric current to the SMA elements will retract the extendable portion.

The under-hood compartment may house an internal combustion engine and a heat exchanger. The engine may be cooled by a fluid circulating through the heat exchanger. The air dam assembly may control the airflow such that the airflow may pass through the heat exchanger for cooling the fluid after the fluid is passed through the engine

The controller may be configured to regulate the actuator according to a load on the engine.

A vehicle employing the above-described system is also disclosed.

The above features and advantages, and other features and advantages of the present disclosure, will be readily apparent from the following detailed description of the embodiment(s) and best mode(s) for carrying out the described invention when taken in connection with the accompanying drawings and appended claims.

### BRIEF DESCRIPTION OF THE DRAWINGS

FIG. 1 is a schematic top view of a vehicle including a folding air dam assembly disposed at an entrance to an under-hood compartment.

FIG. 2 is a schematic close-up perspective view of the folding air dam assembly shown in FIG. 1.

FIG. 3 is a schematic partial cross-sectional side view of the vehicle shown in FIG. 1, with the folding air dam assembly depicted in a stowed position.

FIG. 4 is a schematic partial cross-sectional side view of the vehicle shown in FIG. 1, with the folding air dam assembly depicted in a deployed position.

FIG. 5 is a schematic partial cross-sectional side view of the vehicle shown in FIG. 1, depicting a network of shape memory alloy (SMA) elements integrated into the folding air dam assembly.

### DETAILED DESCRIPTION

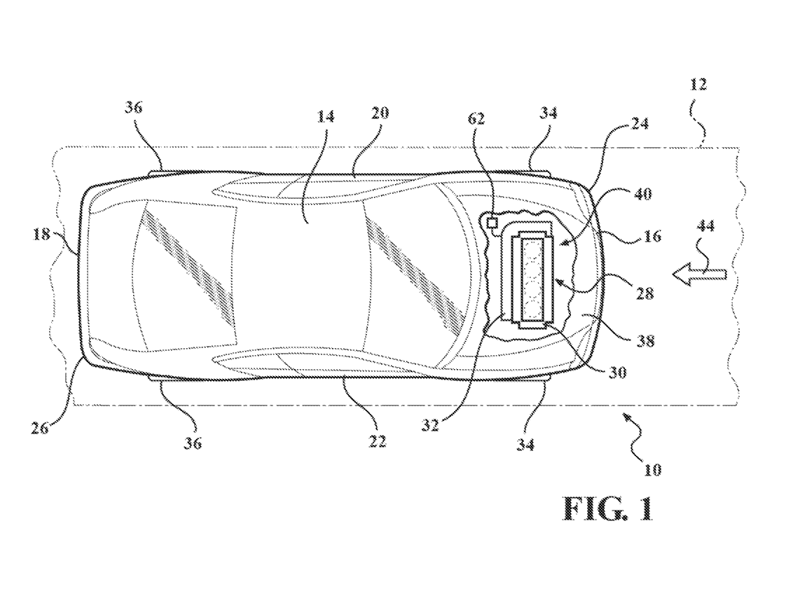

Referring to the drawings, wherein like reference numbers refer to like components, FIG. 1 shows a schematic view of a motor vehicle 10 positioned relative to a road surface 12. The vehicle 10 includes a vehicle body 14. The vehicle body 14 defines four body sides. The four body sides include a first or front end 16, a second or rear end 18, a left side 20, and a right side 22. As shown, the front end 16 may include a bumper assembly 24, while the rear end 18 may include a bumper assembly 26.

The vehicle 10 also includes a powertrain 28 configured to propel the vehicle. As shown in FIG. 1, the powertrain 28 may include an internal combustion (IC) engine 30 and a transmission 32. The powertrain 28 may also include one or more motor/generators as well as a fuel cell, neither of which are shown, but a powertrain configuration employing such devices is appreciated by those skilled in the art. The vehicle 10 also includes front wheels 34 and rear wheels 36. Depending on specific configuration of the powertrain 28, power of the engine 30 may be transmitted to the road surface 12 through the front wheels 34, the rear wheels 36, or through all the wheels 34 and 36.

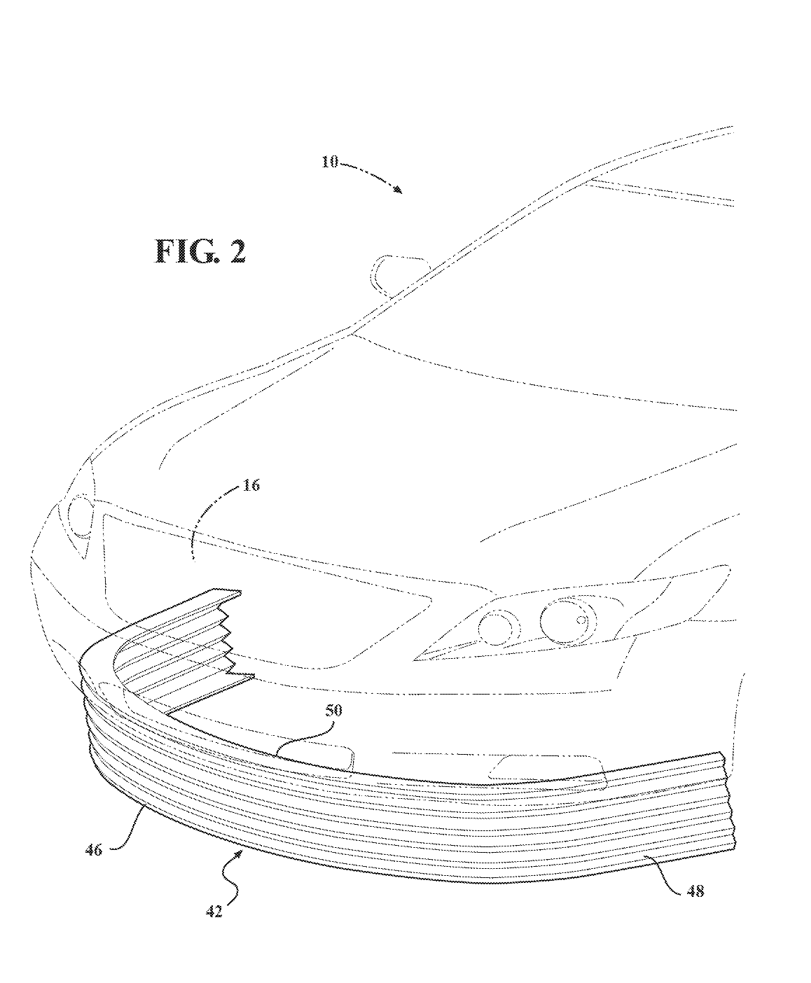

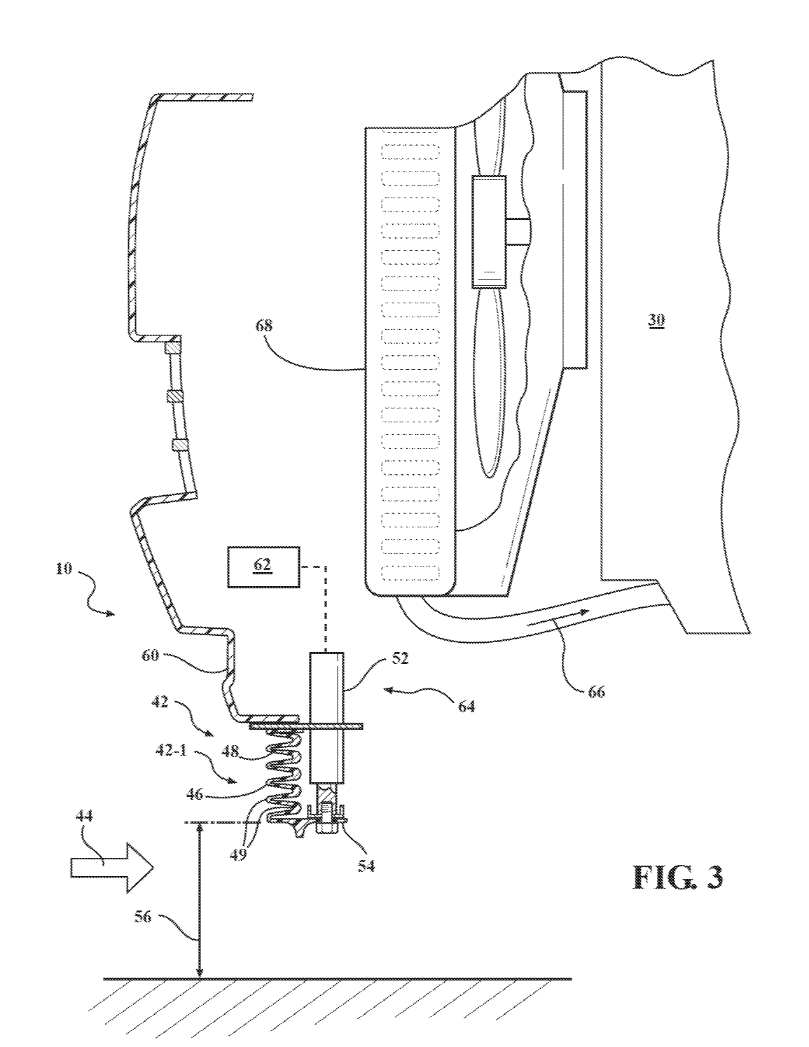

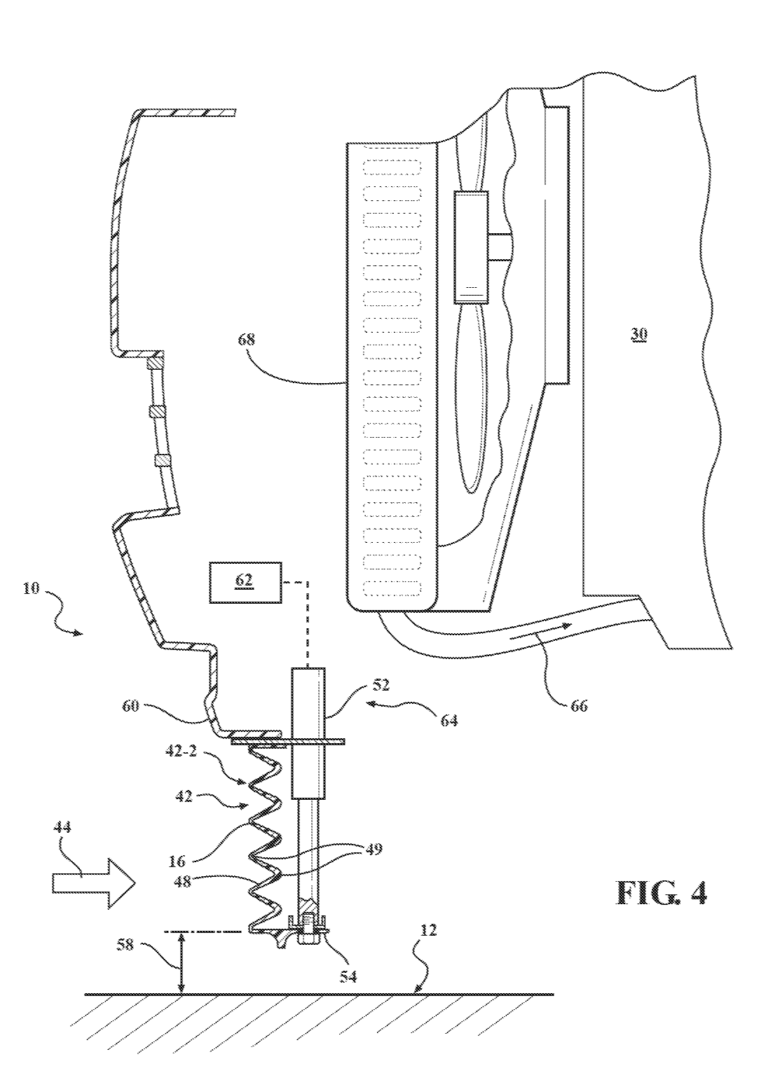

As also shown in FIG. 1, the vehicle body 14 includes a hood 38 configured to cover a portion of the front end 16 of the body to thereby define an under-hood compartment 40, as shown in FIG. 2. A folding air dam assembly 42 is disposed at the front end 16. The folding air dam assembly 42 is configured to divert an airflow 44 from flowing below the vehicle body 14 and to flow around the vehicle 10. Such action of the air dam assembly 42 reduces the air drag normally caused by vehicle components positioned under the vehicle body 14, such as a vehicle suspension and an exhaust system of the engine 30. The folding air dam assembly 42 is also configured to control an airflow 44 from the ambient to the under-hood compartment 40 in order to provide cooling for the powertrain 28, as shown in FIGS. 3 and 4. The air dam assembly 42 is positioned beneath the bumper assembly 24, such that the air dam assembly may be selectively retracted out of the way of the airflow 44 in a stowed position 42-1, as shown in FIG. 3, and extended into the path of the airflow in a deployed position 42-2, as shown in FIG. 4.

The air dam assembly 42 includes an extendable portion 46. The extendable portion 46 includes at least one pleat 48 configured to fold when the extendable portion is taken from the deployed position 42-2 to the stowed position 42-1. As shown in FIG. 2, the extendable portion 46 includes four pleats 48, wherein the actual number of pleats may be selected based on the desired height of the extendable portion in both its extended and refracted states. The individual pleats 48 may be identical or have dissimilar dimensions, again based on the desired height of the extendable portion 46 in the deployed and stowed positions. As shown, the extendable portion 46 is characterized by a monolithic or single-piece accordion type of construction. Such construction may be generated via a plastic molding process so that each individual pleat 48 includes a living hinge 49.

The living hinges 49 may be molded in the retracted state, such that the extendable portion 46 is constantly urged to the stowed position 42-1, as shown in FIG. 3. On the other hand, the living hinges 49 may be molded in the extended state, such that the extendable portion 46 is constantly urged to the deployed position 42-2, as shown in FIG. 4. Furthermore, the living hinges 49 may be molded in an intermediate state, such that the extendable portion 46 is constantly urged into an attitude in between the stowed and deployed positions 42-1 and 42-2. Accordingly, energy may be stored in the living hinges 49 and used to pre-position or bias the extendable portion 46 in the appropriate position.

Additionally, as shown in FIG. 1, the extendable portion 46 includes a curved shape 50 configured to follow the contour of the front end 16 of the vehicle body 14. The curved shape 50 is configured to stiffen the extendable portion 46 by including corresponding curves into the individual pleats 48. As a result of the curved shape 50, bending of the extendable portion 46 due to a force from the oncoming airflow 44, as when the vehicle 10 is traveling at elevated speeds, may be minimized.

As shown in FIGS. 3 and 4, the air dam assembly 42 also includes an actuator 52 configured to selectively extend and retract the extendable portion 46. As shown, the actuator 52 is a linearly-extending device. For example, the actuator 52 may either be a fluidly actuated device, or configured as a servomotor or a solenoid. Additionally, the actuator 52 may be a single unit or include a plurality of individual actuators, such as the ones described above. In the case that a plurality of individual actuators 52 is used, the actuators may be located symmetrically along the front end 16 in order to facilitate uniform extension and retraction of the extendable portion 46 relative to both the left side 20 and the right side 22.

The extendable portion 46 includes a segment 54 disposed substantially orthogonal to the actuator 52. The actuator 52 is operatively connected to the segment 54 for imparting a load onto the extendable portion 46 during selective deployment and stowing thereof. The extendable portion 46 may be configured from a resilient, i.e., tough but flexible, material, such as urethane, in order to withstand numerous stow and deployment cycles. Additionally, the resilient nature of the extendable portion 46 is intended to minimize the possibility of damage to the air dam assembly 42 due to impact from various obstructions, such as parking blocks, and road-borne debris that may be encountered by the vehicle 10.

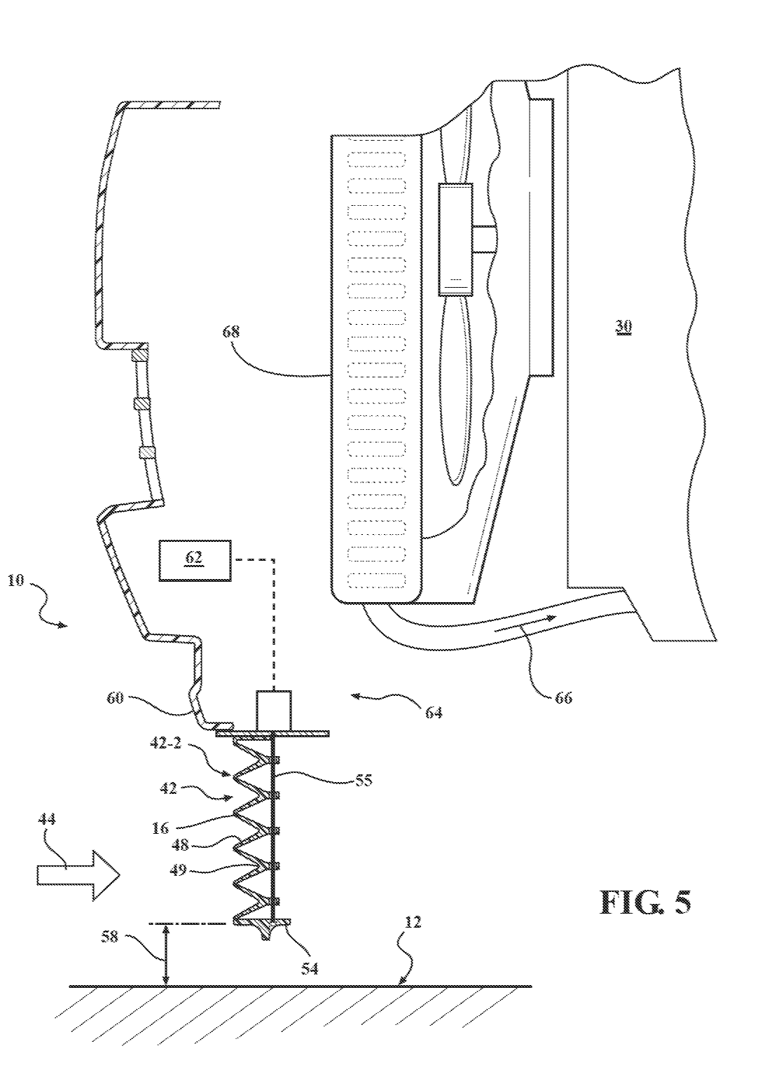

As shown in FIG. 5, the actuator 52 may also be configured as a network of shape memory alloy (SMA) elements 55, such as wires of appropriate shape or cross-section that are integrated into the body of the extendable portion 46. The network of SMA elements 55 operate on the characteristic of SMA wire that upon conduction of electric current through the subject wire, the wire will bend or shorten in length. Such change in the physical characteristic of the SMA elements will in turn overcome the energy stored in the living hinges 49 and cause contracting or folding of the living hinges, thereby retracting the extendable portion 46.

The actuator 52 is configured to selectively extend and retract the extendable portion 46 from the stowed position 42-1 (shown in FIG. 3) to the deployed position 42-2 (shown in FIG. 4), such that the extendable portion is set in a first height 56 at the stowed position and in a second height 58 at the deployed position. As shown in each of FIGS. 3 and 4, the first height 56 is greater than the second height 58. As a result, a smaller opening is generated between the front end 16 and the road surface 12 when the retractable portion 46 is deployed in comparison to an opening that is generated when the extendable portion is stowed.

The first height 56 of the extendable portion 46 is intended to reduce the likelihood of damage to the air dam assembly 42 due to impact from various obstacles frequently encountered on roadways. Additionally, as shown in FIG. 5, the vehicle 10 may also include a fixed air dam 60 configured to substantially conceal the air dam assembly 42 from the airflow 44 and shield the extendable portion 46 from road debris when the retractable portion is at the first height 56 in the stowed position 42-1. Generally, openings that are located at the front of a vehicle, such as the gap between the extendable portion 46 and the road surface 12, as well as various protruding features on the surface of the vehicle body, tend to disturb the flow of air around the vehicle body 14 and degrade the vehicle's aerodynamic signature.

As shown in FIGS. 1, 3, and 4, the vehicle 10 may additionally include a controller 62. Together, the controller 62 and the air dam assembly 42 may form a system 64 employed for controlling the airflow 44 through the under-hood compartment 40. The controller 62 may be a stand-alone unit programmed to regulate the actuator 52. The controller 62 may also be an electronic control unit (ECU) programmed to coordinate operation of the powertrain 28 with the operation of the actuator 52. Accordingly the controller 62 may regulate the IC engine 30, which is cooled by a fluid 66. The fluid 66 is in turn circulated through a heat exchanger 68 that is housed in the under-hood compartment 40, as shown. The airflow 44 controlled by the air dam assembly 42 is then passed through the heat exchanger 68 to cool the fluid 66 after the fluid is passed through the IC engine 30. Therefore, the controller 62 may regulate the actuator 52 according to a load on the IC engine 30 to remove heat from the fluid 66 and provide the requisite engine cooling.

Accordingly, the controller 62 may be programmed to coordinate operation of the air dam assembly 42 with the operation of the powertrain 28 in order to provide appropriate cooling for the powertrain along with an optimized aerodynamic signature for the vehicle 10 during particular vehicle operation. Specifically, when the extendable portion 46 is at the first height 56 in the stowed position 42-1, the aerodynamic signature of the vehicle 10 is improved, but the powertrain cooling is reduced, while when the extendable portion is at the second height 58 in the deployed position 42-2, the reverse is true.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims.

1. A vehicle comprising:
a vehicle body having a first end and a second end;
a hood configured to cover a portion of the first end of the body to thereby define an under-hood compartment; and
a folding air dam assembly disposed at the first end of the body and configured to control an airflow from the ambient to the under-hood compartment, the air dam assembly including:
an extendable portion having a pleat configured to fold when the extendable portion is retracted; and
an actuator configured to selectively extend and retract the extendable portion.

2. The vehicle of claim 1, wherein the actuator is configured to extend linearly.

3. The vehicle of claim 2, wherein the actuator includes a plurality of individual actuators.

4. The vehicle of claim 2, wherein the extendable portion includes a segment disposed substantially orthogonal to the actuator and the actuator is operatively connected to the segment.

5. The vehicle of claim 1, wherein the extendable portion is characterized by monolithic construction and a curved shape configured to at least in part wrap around the first end of the body.

6. The vehicle of claim 1, wherein the extendable portion is formed from a resilient material.

7. The vehicle of claim 1, wherein the actuator is configured to selectively extend and retract the extendable portion from a stowed position to a deployed position, respectively, such that the extendable portion is set in a first height at the stowed position and in a second height at the deployed position, and wherein the first height is greater than the second height.

8. The vehicle of claim 7, wherein the actuator includes a network of shape memory alloy (SMA) elements integrated in the extendable portion such that conduction of electric current to the SMA elements will retract the extendable portion.

9. The vehicle of claim 1, further comprising a controller configured to regulate the actuator.

10. The vehicle of claim 9, wherein:
the under-hood compartment houses an internal combustion engine and a heat exchanger;
the engine is cooled by a fluid circulating through the heat exchanger; and
the air dam assembly controls the airflow such that the airflow is passed through the heat exchanger for cooling the fluid after the fluid is passed through the engine.

11. The vehicle of claim 10, wherein the controller is configured to regulate the actuator according to a load on the engine.

12. A system for controlling airflow through an under-hood compartment of a vehicle body, the system comprising:
a folding air dam assembly configured to control an airflow from the ambient to the under-hood compartment, the air dam assembly including:
an extendable portion having a pleat configured to fold when the extendable portion is retracted; and
an actuator configured to selectively extend and retract the extendable portion; and
a controller configured to regulate the actuator.

13. The system of claim 12, wherein the actuator is configured to extend linearly.

14. The system of claim 13, wherein the actuator includes a plurality of individual actuators.

15. The vehicle of claim 12, wherein the extendable portion is characterized by monolithic construction and includes a curved shape configured to at least in part wrap around the first end of the body.

16. The system of claim 12, wherein the extendable portion is configured from a resilient material.

17. The system of claim 12, wherein the actuator is configured to selectively extend and retract the extendable portion from a stowed position to a deployed position, respectively, such that the extendable portion is set in a first height at the stowed position and in a second height at the deployed position, and wherein the first height is greater than the second height.

18. The system of claim 17, wherein the actuator includes a network of shape memory alloy (SMA) elements integrated in the extendable portion such that conduction of electric current to the SMA elements will retract the extendable portion.

19. The system of claim 12, wherein:
the under-hood compartment houses an internal combustion engine and a heat exchanger;
the engine is cooled by a fluid circulating through the heat exchanger; and
the air dam assembly controls the airflow such that the airflow is passed through the heat exchanger for cooling the fluid after the fluid is passed through the engine.

20. The system of claim 19, wherein the controller is configured to regulate the actuator according to a load on the engine.
